(19) United States
(12) Patent Application Publication
(10) Pub. No.: US 2019/0305344 A1
(43) Pub. Date: Oct. 3, 2019

(54) REDOX FLOW BATTERY INCLUDING AN ELECTROLYTE CONCENTRATION MEASURING INSTRUMENT

(71) Applicant: H2, INC., Daejeon (KR)

(72) Inventors: Shin HAN, Daejeon-Si (KR); Jeehyang HUH, Daejeon-Si (KR); Jingmei PIAO, Daejeon-Si (KR)

(21) Appl. No.: 16/356,338

(22) Filed: Mar. 18, 2019

(30) Foreign Application Priority Data
Mar. 28, 2018 (KR) 10-2018-0035505

(51) Int. Cl. H01M 8/0444; H01M 8/18

(52) U.S. Cl. CPC H01M 8/04477; H01M 8/04455; H01M 8/04447; H01M 8/188

(57) ABSTRACT

The present invention relates to a redox flow battery comprising: an electrolyte tank, an electrolyte inlet pipe, a stack, and a pump supplying an electrolyte in the tank to the stack through an electrolyte inlet pipe, wherein an electrolyte concentration measuring instrument is connected to the electrolyte inlet pipe.

### TECHNICAL FIELD

The present invention relates to a redox flow battery including an electrolyte concentration measuring instrument.

### BACKGROUND ART

Recently, a redox flow battery has been attracting the greatest attention as one of the core products closely associated with renewable energy, reduction in greenhouse gas, secondary batteries, and smart grids. Currently, most of the energy is obtained from fossil fuels, but the use of these fossil fuels has a serious adverse impact on the environment such as air pollution, acid rain, global warming, and low energy efficiency.

In recent years, in order to address the problems, interests in renewable energy and fuel cells have rapidly increased. Interests and researches on such renewable energy are being developed not only domestically but also globally.

Although the renewable energy market has entered the mature stage both domestically and internationally, there is a problem that the amount of generated energy changes according to environmental conditions such as time and weather which are the properties of renewable energy. As a result, an energy storage system (ESS) for storing the generated renewable energy is very demanded to stabilize the grid and the redox flow battery is attracting attention as a large-scale energy storage system.

As an embodiment of the present invention, a structure of the redox flow battery includes a stack 1 with a plurality of cells for electrochemical reaction are stacked, cathode and anode inlet pipes 2A and 2B, catholyte and anolyte tanks 3A and 3B for storing catholyte and anolyte, and pumps 4A and 4B for supplying the catholyte and the anolyte to the stack from the tanks, as illustrated in FIG. 1.

FIG. 2 illustrates a simplified structure of the stack 1 according to the present invention and illustrates an end plate 11, an insulating plate 12, a current plate 13, a bipolar plate 14, a gasket 15, a flow frame 16, an electrode 17, a gasket 15, an ion-exchange membrane 18, a gasket 15, an electrode 17, a flow frame 16, a gasket 15, a bipolar plate 14, a current plate 13, an insulating plate 12, and an end plate 11 from the left side. A unit cell is formed from the bipolar plate 14 to the bipolar plate 14, and generally, one stack is configured by stacking tens to hundreds of unit cells.

An important factor in determining an energy capacity of the redox flow battery is an equilibrium state of active materials in the catholyte and the anolyte. In the redox flow battery, an ion exchange membrane must be used to form an electric circuit. Theoretically, a cation exchange membrane needs to transfer cations and an anion exchange membrane needs to transfer anions. However, actually, undesired ions are transferred by a concentration difference therebetween and water molecules and a balance of the cathode and anode active material concentrations of determining the capacity is broken. Therefore, in order to maintain a constant capacity of the redox flow battery for a long time, a rebalancing operation is necessary and it is necessary to check the state of the active materials in the catholyte and the anolyte in real time for the rebalancing.

For the rebalancing, firstly, the concentrations of the active materials in the electrolyte need to be measured and the electrolyte needs to be sampled and diluted to a certain multiple in order to measure the concentration with a common analyzer.

Since most concentration analyzers are for laboratory rather than for portable, sampling for the analysis is required in the field.

Generally, it is practically impossible to always perform sampling because a distance between the field and the laboratory is long. Therefore, there is a limitation to measuring the electrolyte concentration using the existing methods.

Regarding the redox flow battery electrolyte, there is Korean Patent Registration No. 10-1130575, which is intended to produce vanadium ions, but is not related to the measurement of the electrolyte concentration.

### RELATED ART DOCUMENT

### Patent Document

(Patent Document 1) Korean Patent Registration No. 10-1130575 (registered on Mar. 20, 2012)

### DISCLOSURE

### Technical Problem

The present invention relates to a redox flow battery including an electrolyte concentration measuring instrument and is directed to measure a concentration of an electrolyte in real time even during charging and discharging and to real time rebalance the electrolyte for maintaining a high energy capacity.

The present invention is directed to measure a concentration of an electrolyte through a real time communication process, not analysis by a diluting process of a sample after sampling in the field.

### Technical Solution

The present invention relates to a redox flow battery comprising: an electrolyte tank, an electrolyte inlet pipe, a stack, and a pump supplying an electrolyte in the tank to the stack through the electrolyte inlet pipe, wherein an electrolyte concentration measuring instrument is connected to the electrolyte inlet pipe.

The electrolyte concentration measuring instrument may be connected to an electrolyte inlet pipe by a pipe bypassed to the electrolyte inlet pipe, and the electrolyte transferred to the stack from the electrolyte tank may pass through the electrolyte concentration measuring instrument and then flow into the electrolyte inlet pipe again.

The electrolyte concentration measuring instrument may include a light emitting unit emitting light in a specific wavelength range, a light receiving unit receiving the emitted light, an inlet port to which the electrolyte is introduced, an outlet port from which the electrolyte is discharged, and a container connected with the inlet port and the outlet port between the light emitting unit and the light receiving unit and filled with the electrolyte, and the light emitted from the light emitting unit may pass through the container and then is received at the receiving unit.

In the electrolyte concentration measuring instrument, a relational formula between a concentration value of the electrolyte and a sensor value measured by the light receiving unit may be established based on a plurality of reference data, and then the concentration value of the electrolyte may be obtained by measuring the sensor value.

The electrolyte inlet pipe may be a cathode inlet pipe or an anode inlet pipe.

In the electrolyte concentration measuring instrument, spacers may be installed on both sides of the container and a substrate on which electronic components including the light emitting unit or the light receiving unit are mounted may be installed in each spacer.

The electrolyte concentration measuring instrument may measure the concentrations of two active materials in one of catholyte and anolyte and the concentrations of two active materials in the other of catholyte and anolyte may be calculated based on the measured concentrations.

### Advantageous Effects

According to the present invention, it is possible to figure out a state of charge (SOC) during charging and discharging and find a crossover problem through an ion exchange membrane in real time by an electrolyte concentration measuring instrument.

Further, it is possible to figure out a molar difference in active materials between the catholyte and the anolyte through the measured concentration and volume and to perform rebalancing in real time.

Further, it is possible to improve an energy capacity through real-time rebalancing and to measure an electrolyte concentration and figure out an electrolyte state in real time without electrolyte sampling in the field and diluting the sampled electrolyte.

Therefore, it is possible to reduce the labor costs for sampling and analysis in the field, and particularly, it is possible to remotely figure out a real-time electrolyte state and perform rebalancing for maintaining a high capacity state even when a product is installed in a foreign country.

### DESCRIPTION OF DRAWINGS

FIG. 1 is a schematic diagram of a redox flow battery which is applied to the present invention.

FIG. 2 is a stack configuration diagram of the redox flow battery according to the present invention.

FIG. 3 is a system configuration diagram of the present invention.

FIG. 4 is a configuration diagram of an electrolyte concentration measuring instrument according to the present invention.

FIG. 5 is a circuit diagram for a light emitting diode and a light receiving unit of the device for measuring an electrolyte concentration according to the present invention.

FIG. 6 is another embodiment of the device for measuring an electrolyte concentration according to the present invention.

FIGS. 7A and 7B are plots regarding an electrolyte concentration and a sensor value.

FIG. 8 is a graph displaying rebalancing status according to the present invention.

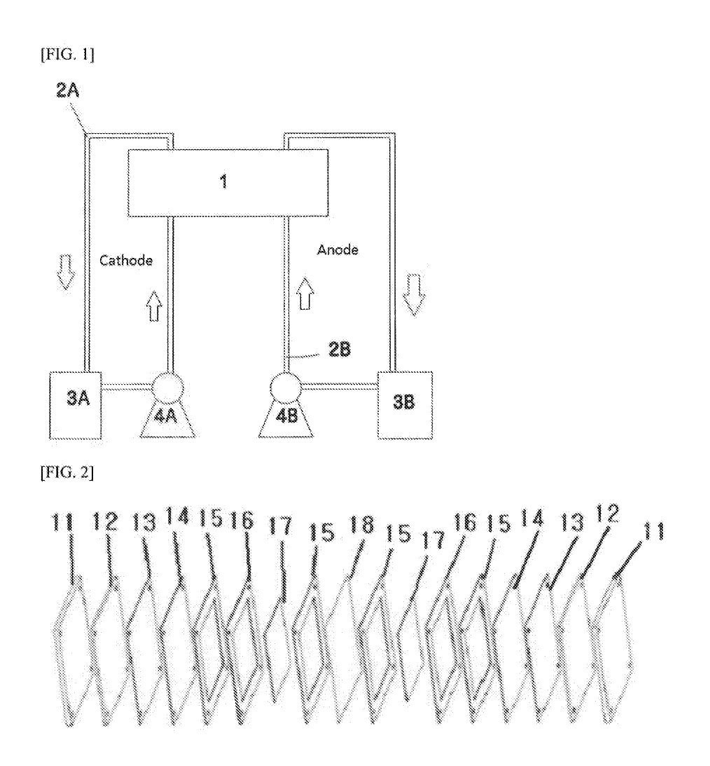

### MODES OF THE INVENTION

The present invention may have various modifications and various embodiments and specific embodiments will be illustrated in the drawings and described in detail in the detailed description. Advantages and features of the present disclosure, and methods for accomplishing the same will be more clearly understood from embodiments described in detail below with reference to the accompanying drawings. However, the present disclosure is not limited to embodiments disclosed below but may be implemented in various different forms. A singular form may include a plural form if there is no clearly opposite meaning in the context. Further, the terms “including”, “having”, etc. mean that there is a feature or a component described in the specification and it is not excluded a possibility that one or more other features or components may be added.

Also, terms “connected” and “connecting” refer to “directly or indirectly connected” and “directly or indirectly connecting”.

Hereinafter, preferred embodiments of the present invention will be described in detail with reference to the accompanying drawings, in which the same or corresponding reference numerals refer to the same or corresponding elements regardless of reference numerals and a duplicated description thereof will be omitted.

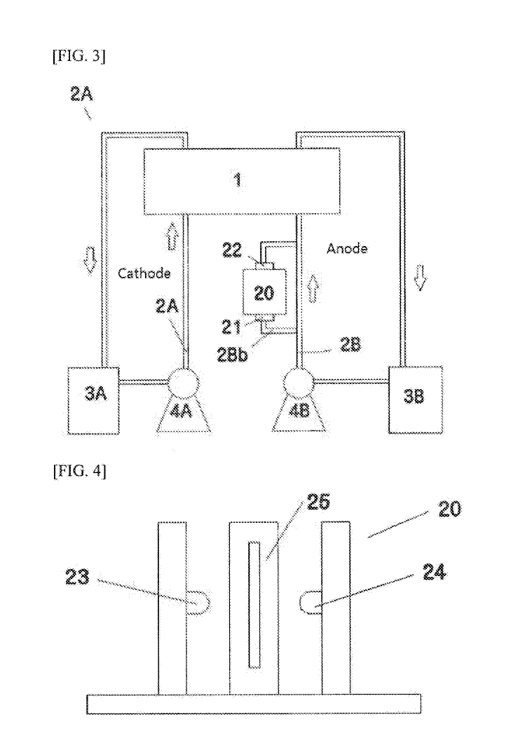

FIG. 3 is a system configuration diagram according to the present invention, and a bypass pipe 2Bb is installed at an anode inlet pipe 2B supplying an anolyte from an anolyte tank 3B to a stack 1 and an electrolyte concentration measuring instrument 20 is installed in the bypass pipe 2Bb.

As such, the bypass pipe is installed at an electrolyte inlet pipe (2A or 2B) supplying the electrolyte to the stack so that the electrolyte passes through the electrolyte concentration measuring instrument and then flows to the electrolyte inlet pipe again, thereby measuring the concentration of the electrolyte supplied to the instrument without requiring a circulation device such as an additional pump.

In FIG. 3, it is illustrated that the electrolyte concentration measuring instrument is installed at an anolyte bypass pipe 2Bb to be bypassed to an anode inlet pipe 2B, but the electrolyte concentration measuring instrument may be installed to a catholyte bypass pipe to be bypassed to a cathode inlet pipe 2A to measure the concentration of the catholyte.

In the redox flow battery, the ratio of an active material in an oxidized state to an active material in a reduced state which are contained in the catholyte changes depending on charging/discharging state. Also, in the anolyte, there exist different ratios in active materials of an oxidized state and a reduced state. That is, the active materials in the four states are present at different ratios depending on a charging/discharging process, but regardless of the state of charging and discharging, the entire active materials contained in the catholyte and anolyte always satisfy the same molar equilibrium and charge equilibrium as the state of the entire active materials contained in the initial catholyte and anolyte.

Therefore, if the concentrations of the active materials in the two states among the four states are known, the concentrations of the active materials in the remaining two states may be known through molar equilibrium and charge equilibrium equations of the entire active materials.

As a result, the present invention includes the electrolyte concentration measuring instrument to figure out the concentration of the active materials in the remaining two states by measuring the concentrations and volume of the active materials in the two states among the active materials in the four states and figure out a molar difference in entire active materials of the catholyte and the anolyte, thereby more accurately enabling rebalancing in real time.

The electrolyte concentration measuring instrument measures the concentrations of active materials in a specific state, thereby more accurately enabling rebalancing in real time.

In FIG. 4, the electrolyte concentration measuring instrument 20 is described in more detail, and the electrolyte concentration measuring instrument 20 consists of a light emitting unit 23, a light receiving unit 24, a container 25, a power supply device, and a circuit and the circuit is configured by components such as a resistor and a universal board.

The container 25 is located between the light emitting unit 23 emitting light in a specific wavelength range and the light receiving unit 24 receiving the light and the light having the specific wavelength may be penetrated through the container.

The absorbance varies depending on a material, a color and a thickness of the container 25 and a distance between the light emitting unit and the light receiving unit.

In the present invention, the container 25 has a thickness of 1 mm to 15 mm and may be made of a material such as transparent plastic, glass, acryl, or the like. The distance between the light emitting unit and the light receiving unit may be 1 mm to 20 mm and the distance between the light emitting unit 23 and the light receiving unit 24 may be adjusted.

The electrolyte, the concentration of which is to be measured, is introduced to an input port 21 of the electrolyte concentration measuring instrument 20 and passes through the container 25 and then the electrolyte is discharged to an output port 22. Therefore, measuring the electrolyte concentration does not affect a normal operation of the redox flow battery and the entire system may measure the concentration of the electrolyte in real time without stop.

FIG. 6 is another embodiment of the electrolyte concentration measuring instrument 20 and spacers 28 are installed on both sides of the container 25.

A printed circuit board 27 including a sensor is installed to traverse the spacer, and the input port 21 and the output port 22 are installed on one side.

As such, the input port 21 and the output port 22 may be configured on one side, and may also be installed on opposite sides of the container 25 as illustrated in FIG. 3.

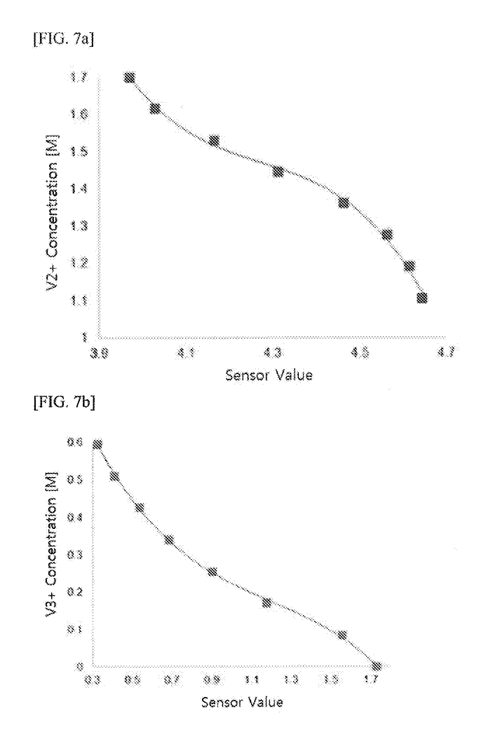

FIGS. 7A and 7B are plots of a relationship between a concentration of the electrolyte and a sensor value through a plurality of reference data, thereby establishing a relational formula.

A reference data test refers to a process of obtaining the relational formula by plotting the sensor value and the concentration value using an electrolyte sample.

The relational formula between the sensor value and the concentration value is obtained through the reference data test, and the sensor value read in real time is applied to the relational formula to obtain the concentration of the electrolyte.

Specifically, when charging is performed in a vanadium redox flow battery, vanadium ions (=active materials) are present as V³⁺ and V²⁺ states in the anolyte and as V⁴⁺ and V⁵⁺ states in the catholyte until the SOC reaches 100%. According to the instrument of the present invention, concentrations of V³⁺ and V²⁺ contained in the anolyte supplied to an anode inlet of the stack may be measured by the electrolyte concentration measuring instrument 20 in real time without an additional diluting process.

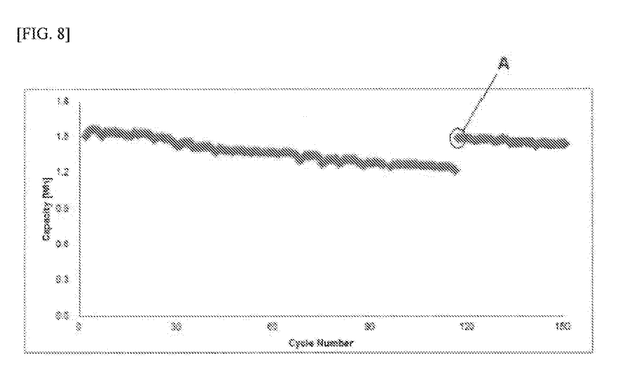

FIG. 8 illustrates that in the stack, a capacity is decreased according to a cycle and then increased at a point A by rebalancing.

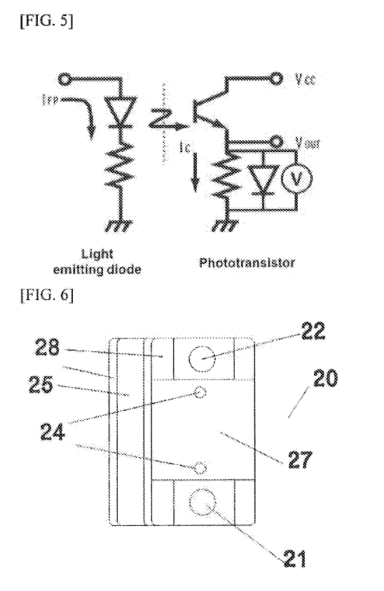

For example, since the absorption range of V³⁺ is 389 nm, a circuit of the electrolyte concentration measuring instrument may be configured using a light emitting unit and a light receiving unit having a ultraviolet absorption range, and since the absorption range of V²⁺ is 850 nm, a circuit may be configured using a emitting unit and a light receiving unit having an infrared absorption range (see FIG. 5). The container 25 uses transparent acrylic having high light transmittance, and a distance between the light receiving unit and the light emitting unit was set to 10 mm. Using the electrolyte concentration device 25, a relationship between a V²⁺ concentration and an IR sensor value (see FIG. 7A) and a relationship between a V³⁺ concentration and a UV sensor value (see FIG. 7B) are plotted to obtain a relational formula. The V³⁺ and V²⁺ concentrations contained in the anolyte may be obtained by measuring the sensor value using the relational formula.

In order to for measure concentrations of two active materials of an electrolyte respectively, the electrolyte concentration measuring instrument may comprise two different light emitting units emitting two different lights and two different light receiving units receiving the two different lights. Also, the electrolyte concentration measuring instrument may comprise two circuits for the different lights.

The aforementioned present invention is not limited to the aforementioned embodiments and the accompanying drawings, and it will be obvious to those skilled in the technical field to which the present invention pertains that various substitutions, modifications, and changes may be made within the scope without departing from the technical spirit of the present invention.

[Explanation of Reference Numerals and Symbols]

| | |
|---|---|
| 1: Stack | 2A, 2B: Cathode and |
| 3A, 3B: Catholyte and an anolyte pumps | anode inlet pipes |
| 4A, 4B: Catholyte and an anolyte pumps | |
| 20: An electrolyte concentration measuring | |
| instrument | |

1. A redox flow battery comprising:
an electrolyte tank, an electrolyte inlet pipe, a stack, and a pump supplying an electrolyte in the tank to the stack through the electrolyte inlet pipe,
wherein an electrolyte concentration measuring instrument is connected to an electrolyte inlet pipe.

2. The redox flow battery of claim 1, wherein the electrolyte concentration measuring instrument is connected to electrolyte inlet pipe by a pipe bypassed to the electrolyte inlet pipe, and an electrolyte supplied to the stack passes through the electrolyte concentration measuring instrument and then flows into the electrolyte inlet pipe again.

3. The redox flow battery of claim 2, wherein the electrolyte concentration measuring instrument includes a light emitting unit emitting light in a specific wavelength range, a light receiving unit receiving the light, an inlet port to which the electrolyte supplied to the stack is introduced, an outlet port from which the electrolyte is discharged, and a container connected with the inlet port and the outlet port between the light emitting unit and the light receiving unit, the light emitted from the light emitting unit passes through the container and then is received at the receiving unit.

4. The redox flow battery of claim 3, wherein in the electrolyte concentration measuring instrument, a relational formula between a concentration of the electrolyte and a sensor value measured by the light receiving unit is established based on a plurality of reference data, and then a concentration value of the electrolyte is obtained by measuring a sensor value and applying the sensor value to the relational formula.

5. The redox flow battery of claim 4, wherein the electrolyte inlet pipe is a cathode inlet pipe or an anode inlet pipe.

6. The redox flow battery of claim 5, wherein in the electrolyte concentration measuring instrument, spacers are installed on both sides of the container and a substrate on which electronic components including the light emitting unit or the light receiving unit are mounted is installed in each spacer.

7. The redox flow battery of claim 6, wherein the electrolyte concentration measuring instrument measures the concentrations of two active materials in one of catholyte and anolyte and the concentrations of two active materials in the other of catholyte and anolyte is calculated based on the measured concentrations.
